(19) United States
(12) Patent Application Publication
(10) Pub. No.: US 2011/0142139 A1
(43) Pub. Date: Jun. 16, 2011

(54) DEVICE FOR DECODING AUDIO AND VIDEO DATA

(75) Inventors: Fan-Chieh Cheng, Keelung City (TW); Shih-Chia Huang, Taipei City (TW); Sy-Yen Kuo, Taipei (TW)

(73) Assignee: ACER INCORPORATED, Taipei Hsien (TW)

(21) Appl. No.: 12/947,200

(22) Filed: Nov. 16, 2010

(30) Foreign Application Priority Data
Dec. 11, 2009 (TW) 98142576

(51) Int. Cl. H04N 7/12

(52) U.S. Cl. 375/240.25; 375/E07.027

(57) ABSTRACT

A device for decoding AV data is provided. The device includes a plurality of sub-buffers to store video data, audio data and subtitle data, so that a data-decoding procedure can be efficiently performed. Besides, a method for providing each picture's information in video data is disclosed. According to the compression standard of the AV data, the method applies a corresponding procedure to provide each picture's information in video data. The picture information is useful to help a decoding unit to correctly decode the video data, so as to generate pictures.

### CROSS REFERENCE TO RELATED APPLICATIONS

This applications claims priority to Taiwan Application No. 98142576 entitled “Device for Decoding Audio and Video Data” filed on Dec. 11, 2009, which application is incorporated herein by reference.

### BACKGROUND OF THE INVENTION

1. Technical Field

The present invention relates to AV decoding devices, and more particularly, to an AV decoding device for generating a picture information conducive to decoding of video data.

2. Description of Related Art

To decode an AV data, a conventional AV decoding device loads an AV data buffer with a part of the AV data. Then, a decapsulator unit retrieves information from the part of the AV data, including video data, audio data, subtitle data, debugging data, and timing data. After all the aforesaid data have been output to their respective sub-buffers and decoded, another part of the AV data are loaded into the AV data buffer, so as to execute the next round of a decoding procedure. However, with only one AV data buffer being stored with data, various functional units preceded by the AV data buffer usually have to wait for the loading of data, thereby deteriorating the decoding efficiency.

Another drawback of the conventional AV decoding device is described hereunder. A picture decoding procedure starts only after the data start position of every picture in the AV data and the data capacity thereof have been obtained; otherwise, any transmission error in the AV data is likely to prevent the AV decoding device from identifying the data end position of a picture, and thus the AV data buffer is overloaded with video data. In view of the above drawbacks of the prior art, it is imperative to provide an AV decoding device for enhancing the efficiency of the operation of a buffer and the accuracy in the information retrieved from every picture, so as to enhance the quality of a video decoding procedure.

### BRIEF SUMMARY OF THE INVENTION

It is an objective of the present invention to provide an AV decoding device for alternately storing a plurality of parts of AV data so as to enhance the efficiency of the decoding of the AV data.

Another objective of the present invention is to provide a method for providing a picture information, so as to provide the information of every picture by following different procedures corresponding to different AV data compression standards, respectively, and then decoding video data accurately with a picture information auxiliary decoding unit.

In an embodiment of the present invention, an AV decoding device is configured to decode an AV data, the device comprising:

an decapsulator unit for decapsulating a first section data of the AV data to output a first video data;

a video buffer unit, electrically coupled to the decapsulator unit, for storing the first video data;

a picture split unit, electrically coupled to the video buffer unit, for providing a picture information of the first video data in a picture; and

a video decoding unit, electrically coupled to the video buffer unit and the picture split unit, for decoding a first picture data of the first video data, based on the picture information, to generate a first picture.

In an embodiment of the present invention, an AV data decoding method for decoding an AV data is provided, the method comprising the steps of:

(a) decapsulating a first section data of the AV data to output a first video data;

(b) performing an information providing procedure, the information providing procedure provides a picture information of the first video data in a picture; and

(c) decoding a first picture data of the first video data, based on the picture information, to generate a first picture.

### BRIEF DESCRIPTION OF THE VIEW OF THE DRAWING

FIG. 1 is a system block diagram of an AV decoding device of the present invention.

### DETAILED DESCRIPTION OF THE PREFERRED EMBODIMENTS

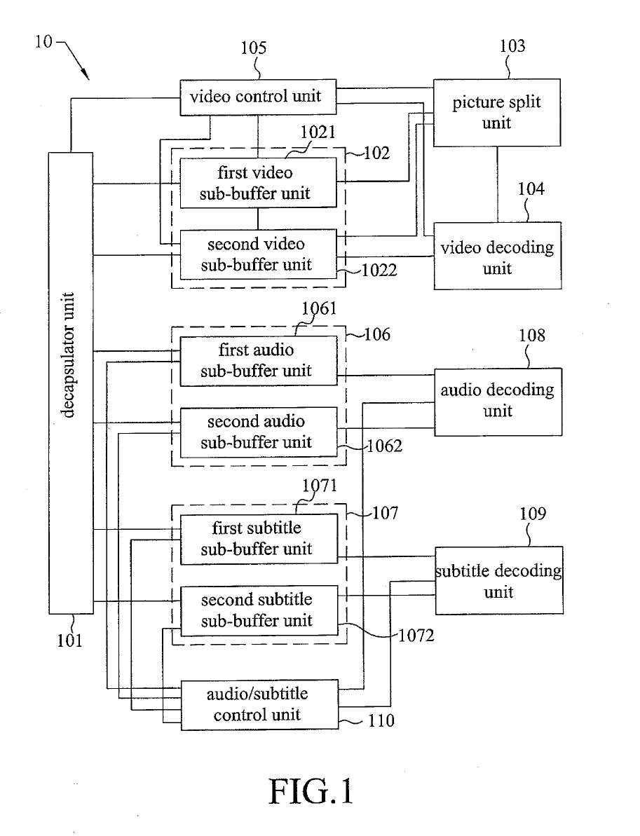

FIG. 1 is a system block diagram of an AV decoding device of the present invention. Referring to FIG. 1, an AV decoding device 10 is configured to decode the AV data. The AV decoding device 10 comprises: an decapsulator unit 101 for decapsulating a part of section data of the AV data; a video buffer unit 102, electrically coupled to the decapsulator unit 101, for storing video data; a picture split unit 103, electrically coupled to the video buffer unit 102, for providing a picture information of the video data in a picture; a video decoding unit 104, electrically coupled to the video buffer unit 102 and the picture split unit 103, for decoding a picture data of the video data, based on the picture information, to generate a picture; and a video control unit 105 electrically coupled to the decapsulator unit 101, the video buffer unit 102, the picture split unit 103, and the video decoding unit 104 to control the units in executing functions thereof.

Also, the AV decoding device 10 further comprises: an audio buffer unit 106, electrically coupled to the decapsulator unit 101, for storing an audio data; a subtitle buffer unit 107, electrically coupled to the decapsulator unit 101, for storing a subtitle data; an audio decoding unit 108, electrically coupled to the audio buffer unit 106, for decoding the audio data to generate an audio; a subtitle decoding unit 109, electrically coupled to the subtitle buffer unit 107, for decoding the subtitle data to generate a subtitle; an audio/subtitle control unit 110, electrically coupled to the decapsulator unit 101, the audio buffer unit 106, the subtitle buffer unit 107, the audio decoding unit 108, and the subtitle decoding unit 109, for controlling the units' performing functions thereof.

To enable the AV decoding device 10 to decode the AV data, a portion of the AV data (or known as a first section data) is loaded to the decapsulator unit 101, and then the decapsulator unit 101 decapsulates the first section data to output a first video data, a first audio data, and a first subtitle data. The first video data thus output is stored in the video buffer unit 102. The first audio data thus output is stored in the audio buffer unit 106. The first subtitle data thus output is stored in the subtitle buffer unit 107.

The picture split unit 103 reads the first video data of the video buffer unit 102 and sends to the video decoding unit 104 the picture information of every picture of the first video data in a picture. The picture information comprises a picture data start point, a picture data end point, or a picture data size, though the present invention is not limited thereto. Also, the picture split unit 103 uses a corresponding procedure to provide the picture information of a video data in a picture according to an AV data compression standard. The procedure employed by the picture split unit 103 is described hereunder.

The video decoding unit 104 decodes every picture of the first video data according to every said picture information. For example, the video decoding unit 104 decodes the first picture, using the picture information corresponding to a first picture. The video control unit 105 controls the decapsulator unit 101, the video buffer unit 102, the picture split unit 103, and the video decoding unit 104 to perform functions thereof.

The first video data comprises at least one picture data or even comprises a portion of the picture data. For instance, in an embodiment, the first video data comprises a first picture data and a portion of a second picture data. Hence, to enable the AV decoding device 10 to decode the AV data efficiently, the present invention proposes that the video buffer unit 102 thereof comprises a first video sub-buffer unit 1021 and a second video sub-buffer unit 1022, though not limited thereto.

In an embodiment of the present invention, the first video data are stored in the first video sub-buffer unit 1021 of the video buffer unit 102. After the picture split unit 103 has provided to the video decoding unit 104 the picture information of the first video data in the first picture according to a procedure, the first video sub-buffer unit 1021 sends a portion of the second picture data of the first video data to the second video sub-buffer unit 1022.

Hence, the video decoding unit 104 decodes the first video data of the first video sub-buffer unit 1021 according to the first picture information so as to generate the first picture; meanwhile, another portion of the AV data (or known as a second section data) that follows the first section data are loaded to the decapsulator unit 101, and then the decapsulator unit 101 decapsulates the second section data to output a second video data, a second audio data, and a second subtitle data. The second video data are stored in the second video sub-buffer unit 1022 of the video buffer unit 102. Also, the second video data comprises the remaining portion of the second picture data and a portion of a third picture data. The portion of the second picture data and the remaining portion of the second picture can be put together to form complete said second picture data.

When the second video sub-buffer unit 1022 comprises complete said second picture data and a portion of the third picture data, the picture split unit 103 provides to the video decoding unit 104 the picture information of the second picture according to a procedure. Afterward, the second video sub-buffer unit 1022 outputs a portion of the third picture data to the first video sub-buffer unit 1021 to proceed to the next round of video data decoding.

As revealed by the above description, the video buffer unit 102 comprises the first video sub-buffer unit 1021 and the second video sub-buffer unit 1022, and thus the AV decoding device 10 of the present invention efficiently and alternately stores the video data for performing a picture data-decoding procedure.

Likewise, to decode the audio data and the subtitle data efficiently, the audio buffer unit 106 of the AV decoding device 10 comprises a first audio sub-buffer unit 1061 and a second audio sub-buffer unit 1062, and the subtitle buffer unit 107 of the AV decoding device 10 comprises a first subtitle sub-buffer unit 1071 and a second subtitle sub-buffer unit 1072, though not limited thereto.

In an embodiment of the present invention, the decapsulator unit 101 decapsulates the first section data to output the first video data, the first audio data, and the first subtitle data. The first audio data are stored in the first audio sub-buffer unit 1061, and the first subtitle data are stored in the first subtitle sub-buffer unit 1071. Afterward, the audio decoding unit 108 decodes the first audio data of the first audio sub-buffer unit 1061 to generate the first audio, and the subtitle decoding unit 109 decodes the first subtitle data of the first subtitle sub-buffer unit 1071 to generate the first subtitle.

In the course of the decoding operation carried out by the audio decoding unit 108 and the subtitle decoding unit 109, the decapsulator unit 101 decapsulates the second section data to output a second video data, a second audio data, and a second subtitle data; meanwhile, the second audio data are stored in the second audio sub-buffer unit 1062, and the second subtitle data are stored in the second subtitle sub-buffer unit 1072. After the first audio data and the first subtitle data have been completely decoded, the audio decoding unit 108 decodes the second audio data to generate the second audio, and the subtitle decoding unit 109 decodes the second subtitle data to generate the second subtitle.

Likewise, as revealed by the above description, the AV decoding device 10 stores the audio data alternately by means of the first audio sub-buffer unit 1061 and the second audio sub-buffer unit 1062, and stores the subtitle data alternately by means of the first subtitle sub-buffer unit 1071 and the second subtitle sub-buffer unit 1072, so as to efficiently perform a procedure for decoding the audio data and the subtitle data.

Furthermore, the picture split unit 103 uses a corresponding procedure to provide the picture information of the video data in every picture according to different AV data compression standards. The procedure employed by the picture split unit 103 according to different AV data compression standards is described hereunder.

In an embodiment of the present invention, when the AV data to be decoded by the AV decoding device 10 is encoded according to MPEG1/MPEG2 compression standard, a procedure whereby the picture split unit 103 provides the picture information comprises the steps of: (a) marking a picture header (PIC) of the video data as a picture data start point; (b) marking a sequence header, a group of picture header (GOP), or another picture header as a picture data end point, wherein the sequence header, the group of picture header, or the another picture header is directly next to the picture header of the first video data; and (c) outputting the picture information having the picture data start point and the picture data end point.

In another embodiment of the present invention, when the AV data to be decoded by the AV decoding device 10 is encoded according to MPEG4 compression standard, a procedure whereby the picture split unit 103 provides the picture information comprises the steps of: (a) marking a visual object plane (VOP) of the video data as a picture data start point; (b) marking a visual object sequence header (VOS), a visual object header (VO), a visual object layer header (VOL), or another visual object plane as a picture data end point, wherein the visual object sequence header, the visual object header, the visual object layer header, or the another visual object plane is directly next to the visual object plane of the first video data; and (c) outputting the picture information having the picture data start point and the picture data end point.

In yet another embodiment of the present invention, when the AV data to be decoded by the AV decoding device 10 is encoded according to H.264 compression standard, a procedure whereby the picture split unit 103 provides the picture information comprises the steps of: (a) marking a network abstraction layer start code (NAL) of the video data as a picture data start point; (b) marking another network abstraction layer start code directly next to the network abstraction layer start code of the first video data as a picture data end point; and (c) outputting the picture information having the picture data start point and the picture data end point.

Regarding the three procedures for providing the picture information, the video data is output after the decapsulator unit 101 has decapsulated the AV data. To provide the picture data of the next picture, the picture data end point of the current picture in step (b) becomes the picture data start point of the next picture, and then the picture data end point of the next picture is provided in step (b).

In an embodiment of the present invention, the picture information of other types is provided. For example, the picture data start point is subtracted from the picture data end point to generate a picture size such that the picture size is treated as one of the picture information, though the present invention is not limited thereto. Furthermore, to render utilization of memory space efficient and speed up data reading, it is feasible for the picture information to be encoded by the picture split unit 103 and then sent to the video decoding unit 104. For example, in an embodiment, the picture information is as follows:

| | |
|---|---|
| Memory Address | Contents (32 bits per field) |

| 0 | first picture data start point | |
|---|---|---|
| 32 | identifier 1 (3 bits) | picture size |
| 64 | identifier 2 (3 bits) | picture size |
| . . . | . . . | . . . |
| 32(n − 1) | Identifier n − 1 (3 bits) | picture size |

Meanings of identifiers are as follows:

| identifier | meaning |
|---|---|
| 000 | end symbol (no picture data) |
| 001 | subsequent 29 bits indicate the size of a |
| | picture |
| 010 | subsequent 13-bit and 16-bit fields |
| | indicate the size of two pictures, |
| | respectively |
| 011 | subsequent 13-bit and 16-bit fields |
| | indicate the differences between two |
| | pictures and the preceding picture, |
| | respectively. |
| 100 | subsequent 5-bit, 8-bit and 8-bit fields |
| | indicate the differences between three |
| | pictures and the preceding picture, |
| | respectively. |
| 101 | reserved purpose |
| 110 | reserved purpose |
| 111 | reserved purpose |

Encoding the picture information in the above manner reduces the amount of data of the picture information, so as to render utilization of memory space efficient and speed up data reading.

As revealed by the above description, the AV decoding device 10 of the present invention uses a plurality of sub-buffer unit for storing a video data, an audio data, and a subtitle data, so as to perform a data-decoding procedure efficiently. Also, the picture split unit 103 uses a corresponding procedure to provide the picture information of the video data in every picture according to different AV data compression standards. The picture information is useful for accurately decoding the video data by the video decoding unit 104 so as to generate a picture.

The foregoing preferred embodiments are provided to illustrate and disclose the present invention but are not intended to be restrictive of the claims of the present invention. Hence, all equivalent modifications and variations made to the foregoing embodiments without departing from the spirit embodied in the disclosure of the present invention should fall within the scope of the invention as set forth in the appended claims.

1. An AV decoding device for decoding an AV data, said device comprising:
an decapsulator unit for decapsulating a first section data of said AV data to output a first video data;
a video buffer unit, coupled to said decapsulator unit, for storing said first video data;
a picture split unit, coupled to said video buffer unit, for providing a picture information of said first video data in a picture; and
a video decoding unit, coupled to said video buffer unit and said picture split unit, for decoding a first picture data of said first video data, based on said picture information, to generate a first picture.

2. The AV decoding device according to claim 1, wherein said video buffer unit comprises a first video sub-buffer unit and a second video sub-buffer unit, and said first video sub-buffer unit stores said first video data.

3. The AV decoding device according to claim 2, wherein if said first video data comprises said first picture data and part of a second picture data, said first video sub-buffer unit outputs said part of said second picture data to said second video sub-buffer unit.

4. The AV decoding device according to claim 3, wherein said decapsulator unit decapsulates a second section data of said AV data to output a second video data to said second video sub-buffer unit, and said second section data follows said first section data.

5. The AV decoding device according to claim 4, wherein if said second video data comprises a remaining part of said second picture data and part of a third picture data, said second video sub-buffer unit outputs said part of said third picture data to said first video sub-buffer unit; wherein said part of said second picture data and said surplus second picture data are combined to form a second picture data.

6. The AV decoding device according to claim 1, wherein said decapsulator unit decapsulates said first section data to output a first audio data and a first subtitle data.

7. The AV decoding device according to claim 6, further comprising:
an audio buffer unit, coupled to said decapsulator unit, for storing said first audio data;
a subtitle buffer unit, coupled to said decapsulator unit, for storing said first subtitle data;
an audio decoding unit, coupled to said audio buffer unit, for decoding said first audio data to generate a first audio; and
an subtitle decoding unit, coupled to said subtitle buffer unit, for decoding said first subtitle data to generate a first subtitle.

8. The AV decoding device according to claim 1, wherein said AV data is encoded according to MPEG1/MPEG2 compression standard.

9. The AV decoding device according to claim 8, wherein said picture split unit is configured to:
mark a picture header of said first video data as a picture data start point;
mark a sequence header, a group of picture header, or another picture header as a picture data end point, wherein said sequence header, said group of picture header, or said another picture header is directly next to said picture header of said first video data; and
output said picture information having said picture data start point and said picture data end point.

10. The AV decoding device according to claim 1, wherein said AV data is encoded according to MPEG4 compression standard.

11. The AV decoding device according to claim 10, wherein said picture split unit is configured to
mark a visual object plane of said first video data as a picture data start point;
mark a visual object sequence header, a visual object header, a visual object layer header, or another visual object plane as a picture data end point, wherein said visual object sequence header, said visual object header, said visual object layer header, or said another visual object plane is directly next to said visual object plane of said first video data; and
output said picture information having said picture data start point and said picture data end point.

12. The AV decoding device according to claim 1, wherein said AV data is encoded according to H.264 compression standard.

13. The AV decoding device according to claim 12, wherein said picture split unit is configured to:
mark a network abstraction layer start code of said first video data as a picture data start point;
mark another network abstraction layer start code directly next to said network abstraction layer start code of said first video data as a picture data end point; and
output said picture information having said picture data start point and said picture data end point.

14. An AV data decoding method for decoding an AV data, said method comprising the steps of:
(a) decapsulating a first section data of said AV data to output a first video data;
(b) performing an information providing procedure, said information providing procedure provides a picture information of said first video data in a picture; and
(c) decoding a first picture data of said first video data, based on said picture information, to generate a first picture.

15. The AV data decoding method according to claim 14, wherein said AV data is encoded according to MPEG1/MPEG2 compression standard.

16. The AV data decoding method according to claim 15, wherein said information providing procedure comprising the steps of:
(d1) marking a picture header of said first video data as a picture data start point;
(d2) marking a sequence header, a group of picture header, or another picture header as a picture data end point, wherein said sequence header, said group of picture header, or said another picture header is directly next to said picture header of said first video data; and
(d3) outputting said picture information having said picture data start point and said picture data end point.

17. The AV data decoding method according to claim 14, wherein said AV data is encoded according to MPEG4 compression standard.

18. The AV data decoding method according to claim 17, wherein said information providing procedure comprising the steps of:
(e1)) marking a visual object plane of said first video data as a picture data start point;
(e2) marking a visual object sequence header, a visual object header, a visual object layer header, or another visual object plane as a picture data end point, wherein said visual object sequence header, said visual object header, said visual object layer header, or said another visual object plane is directly next to said visual object plane of said first video data; and
(e3) outputting said picture information having said picture data start point and said picture data end point.

19. The AV data decoding method according to claim 14, wherein said AV data is encoded according to H.264 compression standard.

20. The AV data decoding method according to claim 19, wherein said information providing procedure comprising the steps of:
(f1) marking a network abstraction layer start code of said first video data as a picture data start point;
(f2) marking another network abstraction layer start code directly next to said network abstraction layer start code of said first video data as a picture data end point; and
(f3) outputting said picture information having said picture data start point and said picture data end point.
